(19) United States
(12) Patent Application Publication
(10) Pub. No.: US 2025/0332906 A1
(43) Pub. Date: Oct. 30, 2025

(54) POWERTRAIN FOR A MOTOR VEHICLE

(71) Applicant: FEV Group GmbH, Aachen (DE)

(72) Inventor: Manpreet CHADHA, Aachen (DE)

(73) Assignee: FEV Group GmbH, Aachen (DE)

(21) Appl. No.: 19/187,245

(22) Filed: Apr. 23, 2025

(30) Foreign Application Priority Data
Apr. 24, 2024 (DE) 102024111551.3

(51) Int. Cl. B60K 6/26; B60K 6/365; B60K 6/38; B60K 6/40; F16H 1/46; H02K 5/24; H02K 7/00; H02K 7/108; H02K 7/116

(52) U.S. Cl. CPC B60K 6/26; B60K 6/365; B60K 6/38; B60K 6/40; F16H 1/46; H02K 5/24; H02K 7/006; H02K 7/108; H02K 7/116; B60K 2006/266; B60Y 2200/92; B60Y 2400/60; B60Y 2400/73

(57) ABSTRACT

A powertrain for a motor vehicle includes a first electromotive drive module. The first electromotive drive module includes an electric motor and a planetary gear. The electric motor is an inner rotor comprising and internally attached rotor which is circumferentially enclosed by a stator. The inner rotor encloses circumferentially the planetary gear. The planetary gear of the first electromotive drive module can be coupled to a second electromotive drive module. The planetary gear of the first electromotive drive module can be coupled to an internal combustion engine.

### CROSS-REFERENCE TO RELATED APPLICATIONS

This application claims priority to DE 10 2024 111 551.3, filed Apr. 24, 2024. The disclosure of the above application is incorporated herein by reference.

### FIELD

The present disclosure relates to a powertrain for a motor vehicle.

### BACKGROUND

The statements in this section merely provide background information related to the present disclosure and may not constitute prior art.

Modern drive concepts rely on hybrid motorizations and purely electromotive motorizations. However, vehicle platforms and their associated powertrains must be flexible and scalable in order to be able to realize a wide spectrum of services and different powertrain concepts in a cost-effective manner.

### SUMMARY

This section provides a general summary of the disclosure and is not a comprehensive disclosure of its full scope or all of its features.

The present disclosure aims to provide a powertrain for a motor vehicle, which is an efficient combination of various powertrain concepts and which is particularly flexible and scalable.

Such a powertrain is described by the features of the independent claim. Other aspects of the present invention can be derived from the dependent claims and the description below.

According to the invention, a powertrain for a motor vehicle is specified as comprising a first electromotive drive module, wherein the first electromotive drive module is provided an electric motor and a planetary gear and wherein the electric motor is an inner rotor comprising an internally attached rotor which is circumferentially enclosed by a stator and wherein the planetary gear of the first electromotive drive module can be coupled to a second electromotive drive module and wherein the planetary gear of the first electromotive drive module can be coupled to an internal combustion engine.

The design of the electric motor with an integrated planetary gear allows a two-sided coupling of other drives in series, so that the first electromotive drive module can be efficiently expanded by an internal combustion engine and/or other electromotive drive modules.

Therefore, depending on the drive concept required, the first electromotive drive module can be used on its own as single motor of a powertrain or as drive module to be expanded by other motors.

The rotor can be coupled to a sun gear of the planetary gear of the first electromotive drive module wherein it is possible to couple a planet carrier of the planetary gear of the first electromotive drive to a second electromotive drive module and wherein a ring gear of the planetary gear of the first electromotive drive module can be coupled to the internal combustion engine. Thus, it is possible to realize a compact coupling of additional drives.

It can be provided that a shaft of the planetary gear penetrates the sun gear, extending in axial direction and projecting beyond the sun gear at a first side of the electromotive drive module.

The powertrain can be provided a second electromotive drive module, wherein the planetary gear of the first electromotive drive module is coupled to the planetary gear of the second electromotive drive module, in particular by means of a clutch or the like. Essentially, the second electromotive drive module can be designed identically to the first electromotive drive module.

Compared to a solution, wherein the first electromotive drive module is used as only motor in a powertrain, basically the first electromotive drive module can be connected in series to a second electromotive drive module without altering the design. It is understood that a clutch or the like is provided for coupling the first electromotive drive module to the second electromotive drive module.

A shaft of the planetary carrier of the first electromotive drive module for instance, can be coupled to an internal gear of the planetary gear of the second electromotive drive module. Thus, it is possible to realize a compact coupling of the planetary gear of the second electromotive drive to the planetary gear of the first automative drive module.

The powertrain can comprise a third electromotive drive module, wherein the planetary gear of the second electromotive drive module is coupled to the planetary gear of the third electromotive drive module, in particular by means of a clutch or the like. Basically, the third electromotive drive module can be designed identically to the first electromotive drive module and to the second electromotive drive module and also be provided an electric motor comprising an integrated planetary gear.

It is understood that the powertrain according to the invention can be expanded by further electromotive drive modules so that the powertrain can comprise four, five or more electromotive drive modules.

The powertrain can be provided an internal combustion engine, wherein in particular the ring gear of the planetary gear of the first electromotive drive module is coupled to the internal combustion engine.

The second electromotive drive module can be arranged at the first side of the first electromotive drive module and the internal combustion engine can be arranged at a second side of the electromotive drive module facing away from the first side of the first electromotive drive module. Thus, it is possible to achieve a compact series connection of the motors in axial direction.

The powertrain can be provided a gear for speed reduction, in particular a spur gear or planetary gear. In this manner an efficient operation of the electric motor or electric motors can be ensured.

The powertrain can be provided a dampening element. In particular, the dampening element can be arranged between the internal combustion engine and the first electromotive drive module.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a first powertrain according to the present disclosure;

FIG. 2 is a schematic view of a second powertrain according to the present disclosure;

FIG. 3 is a schematic view of a third powertrain according to the present disclosure; and

FIG. 4 is a schematic view of a fourth powertrain according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

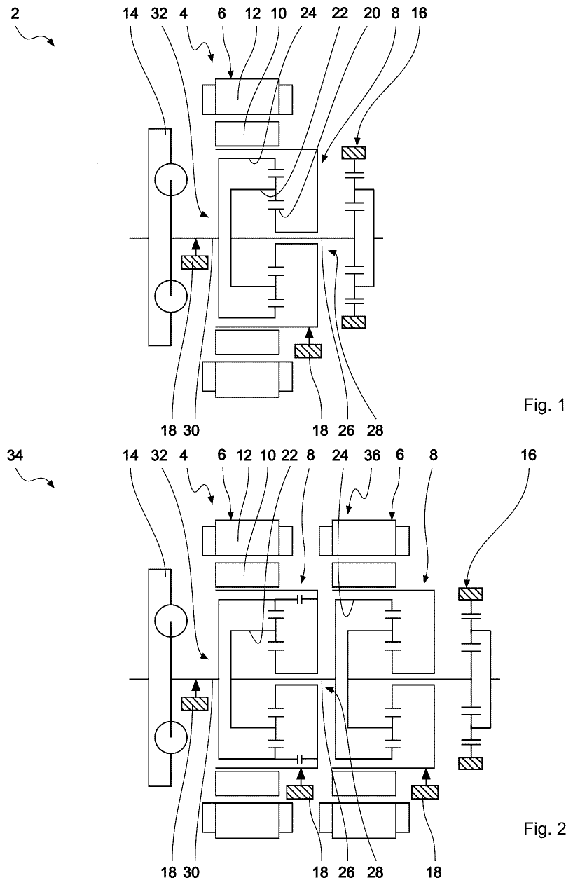

FIG. 1 shows a first powertrain according to the invention. The powertrain 2 comprises a first electromotive drive module 4, wherein the first electromotive drive module 4 comprises an electric motor 6 and a planetary gear 8. The electric motor 6 is an internal rotor comprising an internally attached rotor 10, which is enclosed circumferentially by a stator 12 of the electric motor 6. The rotor 10 encloses the planetary gear 8 circumferentially. The planetary gear 8 of the first electromotive drive module 4 can be coupled to a second electromotive drive module. The planetary gear 8 of the first electromotive drive module 4 can be coupled to an internal combustion engine. Said embodiments will be described later in detail. In the present embodiment, the powertrain 2 is provided solely the electric motor 6 as single motor.

Optionally, the electromotive drive module 4 can be assigned a dampening device 14, a gear 16, and a clutch 18 as part of the powertrain 2.

The gear 16 has been shown here also as planetary gear. According to alternative embodiments of the invention, the gear can be provided as a spur gear.

In the present embodiment, the rotor 10 is coupled to a sun gear 20 of the planetary gear 8 of the first electromotive drive module 4. A planetary carrier 22 of the planetary gear 8 of the first electromotive drive module 4 can be coupled to the second electromotive drive module. A ring gear 24 of the planetary gear 8 of the first electromotive drive module 4 can be coupled to the internal combustion engine.

In the present embodiment, a shaft 26 of the planetary carrier 22 penetrates the sun gear 20 in axial direction, projecting at a first side 28 of the electromotive drive module 4 beyond the sun gear 20.

A shaft 30 of the ring gear 24 extends in a direction facing away from the planetary carrier 22 at a second side 32 facing away from the first side 28 of the first electromotive drive module 4 in order to allow an internal combustion engine to be connected.

FIG. 2 shows another powertrain 34 according to the invention. In order to avoid repetitions, in the following only the differences between those two embodiments shall be described, wherein the same reference numerals are used for identical features.

In addition to the first electromotive drive module 4, the powertrain 42 is provided with a second electromotive drive module 36. In principle, the second electromotive drive module 36 is structurally identical to the first electromotive drive module 4.

The planetary gear 8 of the first electromotive drive module 4 is coupled to the planetary gear 8 of the second electromotive drive module 36. The shaft 26 of the planetary carrier 22 of the first electromotive drive module 4 is coupled to a ring gear 24 of the planetary gear 8 of the second electromotive drive module 36.

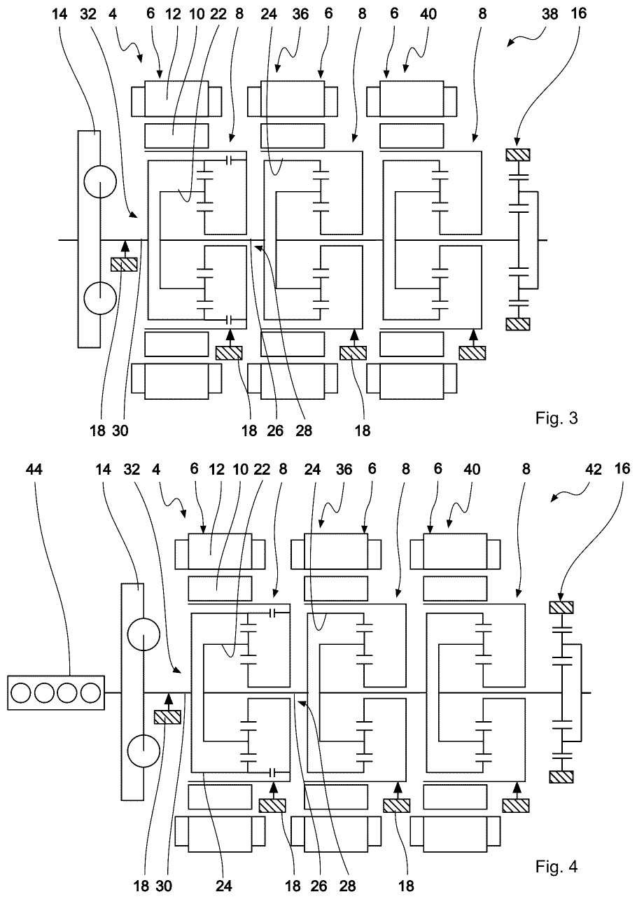

FIG. 3 shows another powertrain 38 according to the invention. In order to avoid repetitions, in the following only the differences between those two embodiments shall be described, wherein same reference numerals are used for identical features.

In addition to the first electromotive drive module 4 and the second electromotive drive module 36, the powertrain 38 is provided with a third automative drive module 40. In principle, the third electromotive drive module 40 is structurally identical to the first electromotive drive module 4 and the second electromotive drive module 36. The planetary gear 8 of the second electromotive drive module 36 is coupled to the planetary gear 8 of the third electromotive drive module 40.

FIG. 4 shows another powertrain 42 according to the invention. In order to avoid repetitions, in the following only the differences between those two embodiments shall be described, wherein same reference numerals are used for identical features.

In addition to the electromotive drive modules 4, 36 and 40, the powertrain 42 is provided with an internal combustion engine 44. The ring gear 24 of the planetary gear 8 of the first electromotive drive 4 is coupled to the internal combustion engine 44. The second electromotive drive module 36 is arranged at the first side 28 of the first electromotive drive module 4. The internal combustion engine 44 is arranged at the second side 32 of the first electromotive module 4 facing away from the first side 28 of the electromotive drive module 4.

It is understood that similar to FIG. 4, concepts according to FIG. 1, FIG. 2 or FIG. 3 can be combined with an internal combustion engine 44 as well.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A powertrain for a motor vehicle, comprising:
a first electromotive drive module comprising an electric motor and a planetary gear,
wherein the electric motor is an internal rotor comprising an internally attached rotor which is circumferentially enclosed by a stator, the internal rotor enclosing the planetary gear circumferentially, and
wherein the planetary gear is couplable to at least one of a second electromotive drive module and an internal combustion engine.

2. The powertrain according to claim 1, wherein:
the planetary gear of the first electromotive drive module comprises a sun gear, a planetary carrier, and a ring gear;
the internal rotor is coupled to the sun gear of the planetary gear of the first electromotive drive module;
the planetary carrier of the planetary gear of the first electromotive drive module is couplable to the second electromotive drive module; and
the ring gear of the planetary gear of the first electromotive drive module is couplable to the internal combustion engine.

3. The powertrain according to claim 2, wherein the planetary carrier includes a shaft penetrating the sun gear and extending in an axial direction at a first side of the first electromotive drive module projecting beyond the sun gear.

4. The powertrain according to claim 1, wherein the second electromotive drive module comprises a planetary gear, wherein the planetary gear of the first electromotive drive module is coupled to the planetary gear of the second electromotive drive module.

5. The powertrain according to claim 4, further comprising a clutch configured to couple the planetary gear of the first electromotive drive module to the planetary gear of the second electromotive drive module.

6. The powertrain according to claim 3, wherein the shaft of the planetary carrier of the first electromotive drive module is coupled to a ring gear of a planetary gear of the second electromotive drive module.

7. The powertrain according to claim 4, further comprising a third electromotive drive module including a planetary gear, wherein the planetary gear of the second electromotive drive module is coupled to the planetary gear of the third electromotive drive module.

8. The powertrain according to claim 7, further comprising a clutch configured to couple the planetary gear of the second electromotive drive module to the planetary gear of the third electromotive drive module.

9. The powertrain according to claim 2, wherein the ring gear of the planetary gear of the first electromotive drive module is coupled to the internal combustion engine.

10. The powertrain according to claim 3, wherein the second electromotive drive module is arranged at the first side of the first electromotive drive module, and the internal combustion engine is arranged at a second side of the first electromotive drive module facing away from the first side of the first electromotive drive module.

11. The powertrain according to claim 1, further comprising a gear for speed reduction.

12. The powertrain according to claim 1, further comprising a dampening element.
